(19) United States
(12) Patent Application Publication
(10) Pub. No.: US 2025/0392127 A1
(43) Pub. Date: Dec. 25, 2025

(54) Method and System for Siting and Sizing Flexible Soft Switch of Distribution Network Based on Mixed Second-order Cone Programming

(71) Applicant: Guizhou Power Grid Co., Ltd., Guiyang (CN)

(72) Inventors: Ludong CHEN, Guiyang (CN); Fei ZHENG, Guiyang (CN); Ning LUO, Guiyang (CN); Jinsen LIU, Guiyang (CN); Pengcheng ZHANG, Guiyang (CN); Jie WANG, Guiyang (CN); Qingyu ZHAO, Guiyang (CN); Mao MIAO, Guiyang (CN); Molin HE, Guiyang (CN); Chang XU, Guiyang (CN); Yan ZHANG, Guiyang (CN); Yu ZHANG, Guiyang (CN); Xiaolong WANG, Guiyang (CN); Xianglong ZHANG, Guiyang (CN); Maosheng WANG, Guiyang (CN); Xianping JIA, Guiyang (CN); Jinsong YU, Guiyang (CN); Lishun YANG, Guiyang (CN); Jianshuai GUO, Guiyang (CN); Shengbai QUAN, Guiyang (CN)

(21) Appl. No.: 19/014,873

(22) Filed: Jan. 9, 2025

Related U.S. Application Data
(63) Continuation of application No. PCT/CN2024/138089, filed on Dec. 10, 2024.

(30) Foreign Application Priority Data
Jun. 19, 2024 (CN) 2024107897933

(51) Int. Cl. H02J 3/00; G06Q 50/06

(52) U.S. Cl. CPC H02J 3/0075; G06Q 50/06; H02J 2203/20

(57) ABSTRACT

The present invention discloses a method for siting and sizing a flexible soft switch of a distribution network based on mixed second-order cone programming, including: acquiring interconnected flexible distribution system data; establishing and optimizing, based on the interconnected flexible distribution system data and an interconnected flexible distribution system constraint, a flexible soft switch siting and sizing model with a minimal daily comprehensive operation cost as an objective; and acquiring an optimal flexible soft switch siting and sizing solution by using combination of an improved sparrow algorithm and second-order cone programming to solve. The present invention is both reliable and economic.

### CROSS-REFERENCE TO RELATED APPLICATIONS

The present application claims priority to Chinese Patent Application No. 2024107897933, filed on Jun. 19, 2024, the entire disclosure of which is incorporated herein by reference.

### TECHNICAL FIELD

The present invention relates to the field of distribution network optimization technologies, and in particular, to a method and system for siting and sizing a flexible soft switch of a distribution network based on mixed second-order cone programming.

### BACKGROUND

With the rapid advancement of a novel power system, power interaction between source network load storage equipment has become closer and closer, which has brought unprecedented challenges to a traditional distribution network. A “closed-loop design and open-loop operation” mode of the traditional distribution network has shown powerless signs in response to increasingly complicated operation demands of a grid structure. This mode mainly relies on one-way energy flow of an AC power grid, but its inherent structural mode lacks sufficient flexibility and has limited control means, which is difficult to meet the demands on modern diversified and complicated power systems.

Meanwhile, rapid development of a new energy generation technology has made a higher proportion of distributed generation (DG) accessing to a power grid become the norm. Wide access of DG does help reduce a transmitted power loss of a system and environmental pollution, but its own volatility and randomness also bring complexity to a power flow power distribution of the power grid, which puts forward higher requirements for power supply quality, network congestion and safe operation of the equipment.

### SUMMARY

An objective of the present part is to provide an overview for some aspects of the embodiments of the present invention and a brief description for some preferred embodiments. Some simplifications or omissions may be made in the present part as well as the abstract of the specification and the title of invention of the present application, so as not to obscure the objective of the present part as well as the abstract of the specification and the title of invention; however, such simplifications or omissions cannot be used for limiting the scope of the present invention.

In view of the existing problems mentioned above, the present invention is proposed. Therefore, the present invention provides a method for siting and sizing a flexible soft switch of a distribution network based on mixed second-order cone programming, aiming to solve the problems of insufficient flexibility, limited control means, and economic optimization faced by a traditional distribution network in dealing with wide access of new energy and a complicated grid structure operation.

In order to solve the above technical problems, the present invention provides the following technical solutions:

In a first aspect, the present invention provides a method for siting and sizing a flexible soft switch of a distribution network based on mixed second-order cone programming, including:
acquiring interconnected flexible distribution system data;
establishing, based on the interconnected flexible distribution system data and an interconnected flexible distribution system constraint, a flexible soft switch siting and sizing programming model of a flexible distribution network with a minimal daily comprehensive operation cost as an objective function;
acquiring a flexible soft switch siting and sizing solution by using combination of an improved sparrow algorithm and second-order cone programming to solve and optimize the flexible soft switch siting and sizing programming model of the flexible distribution network; and
acquiring an optimal flexible soft switch siting and sizing solution by computing an objective function corresponding to the flexible soft switch siting and sizing solution.

As a preferred solution of the method for siting and sizing the flexible soft switch of the distribution network based on mixed second-order cone programming of the present invention, the interconnected flexible distribution system constraint includes a flexible soft switch operation constraint, a flexible soft switch reactive power constraint, a flexible soft switch capacity constraint, a power flow constraint, a system voltage constraint, a branch capacity constraint, and an energy storage equipment constraint.

As a preferred solution of the method for siting and sizing the flexible soft switch of the distribution network based on mixed second-order cone programming of the present invention, the objective function includes:
the daily comprehensive operation cost comprises a main network output cost, an operation loss cost, and an energy storage charging and discharging loss cost; and
the main network output cost, the operation loss cost, and the energy storage charging and discharging loss cost are expressed as:

$${C}_{pg} = {\sum }_{t = 1}^{T} {C}_{gt} {P}_{gt}$$

$${C}_{loss} = {C}_{\text{?}} {\sum }_{i = 1}^{{N}_{\text{?}}} {\sum }_{j ∈ c ( \text{?} )} {{R}_{ij} ( {I}_{ij} )}^{2} + {\sum }_{\text{?} = 1}^{T} {\sum }_{\text{?} ∈ {ϕ}_{\text{?}}} {C}_{sop} {P}_{loss , \text{?} , t} Δ T$$

$${C}_{Ess} = {\sum }_{\text{?} = 1}^{T} {\sum }_{\text{?} ∈ {ψ}_{ess}} {C}_{ess} ( {P}_{\text{?} , t}^{ch} + {P}_{\text{?} , t}^{\text{?}} )$$

$$\text{?} \text{indicates text missing or illegible when filed}$$

wherein C_{pg} is the main network output cost, Cₗₒₛₛ is the operation loss cost, C_{ESS} is the energy storage charging and discharging loss cost, C_{gl} represents a real-time electricity purchase price of the distribution network, P_{gi} represents a system real-time power in electricity purchase, Cₑ is a system network loss compensation coefficient, Cₛₒₚ is a reduced unit price of a flexible soft switch operation cost, N_{bus} is a number of system network nodes, c(i) is a set with node i as an initial node, P_{loss,j,t} is a transmitted power loss of flexible soft switch port i at time t, Iᵢⱼ is a current flowing through a line between node i and node j, Cₑₛₛ represents an energy storage equipment cost coefficient, ψₑₛₛ represents an energy storage equipment installation position set in a system, and

$${P}_{\text{?} , t}^{ch} and {P}_{\text{?} , t}^{dis}$$

$$\text{?} \text{indicates text missing or illegible when filed}$$

represent charging and discharging powers of energy storage equipment at node i at time t respectively.

As a preferred solution of the method for siting and sizing the flexible soft switch of the distribution network based on mixed second-order cone programming of the present invention, the solving the flexible soft switch siting and sizing programming model of the flexible distribution network by using the improved sparrow algorithm includes:
initializing parameters of the sparrow algorithm, performing coding by determining an initial access position of the flexible soft switch as a decision variable of the improved sparrow algorithm, and randomly generating the flexible soft switch siting and sizing solution;
making a flexible soft switch connection port unrepeated and the flexible soft switch port not connected to a head node of the distribution network; and
introducing the Levy flight strategy into an iterative solution process of the sparrow algorithm, and adding interference to the flexible soft switch siting and sizing solution by adding a Levy flight item to an update of the flexible soft switch siting and sizing solution with an optimal objective function value.

As a preferred solution of the method for siting and sizing the flexible soft switch of the distribution network based on mixed second-order cone programming of the present invention, the optimizing the flexible soft switch siting and sizing programming model of the flexible distribution network by using second-order cone programming includes:
converting the flexible soft switch operation constraint, the flexible soft switch reactive power constraint, the flexible soft switch capacity constraint, and the power flow constraint to a second-order cone optimization model through linearization and second-order cone relaxation, and then solving the second-order cone optimization model by using a SOCP algorithm.

As a preferred solution of the method for siting and sizing the flexible soft switch of the distribution network based on mixed second-order cone programming of the present invention, the method further includes:
the solving the second-order cone optimization model by using a SOCP algorithm is expressed as:

$${‖ \begin{matrix}{P}_{\text{?}}^{link} \\ {Q}_{\text{?}}^{link}\end{matrix} ‖}_{2} \leq \frac{{P}_{\text{?}}^{link , loss}}{{A}_{\text{?}}^{link}}$$

$${‖ \begin{matrix}{P}_{\text{?}}^{link} \\ {Q}_{\text{?}}^{link}\end{matrix} ‖}_{2} \leq {S}_{\text{?}}^{link}$$

$${\sum }_{\text{?} \to j} ( {P}_{ij} - {R}_{ij} {I}_{ij}^{\text{?}} ) - {P}_{j} = {\sum }_{\text{?} \to \text{?}} {P}_{\text{?}}$$

$${\sum }_{\text{?} \to j} ( {Q}_{ij} - {X}_{ij} {I}_{ij}^{\text{?}} ) - {Q}_{\text{?}} = {\sum }_{\text{?} j \to \text{?}} {Q}_{\text{?}}$$

$${u}_{j} = {u}_{i} - 2 ( {R}_{ij} {P}_{ij} + {X}_{ij} {Q}_{ij} ) + ( {R}_{ij}^{2} + {X}_{ij}^{2} ) {I}_{ij}^{\text{?}}$$

$${‖ \begin{matrix}2 {P}_{\text{?}} \\ 2 {Q}_{\text{?}} \\ {I}_{\text{?}}^{\text{?}} - {u}_{\text{?}}\end{matrix} ‖}_{2} ≦ {I}_{\text{?}}^{\text{?}} + {u}_{\text{?}}$$

$$\text{?} \text{indicates text missing or illegible when filed}$$

wherein

$${P}_{\text{?}}^{link} and {P}_{j}^{link}$$

$$\text{?} \text{indicates text missing or illegible when filed}$$

as well as

$${Q}_{\text{?}}^{link} and {Q}_{j}^{link}$$

$$\text{?} \text{indicates text missing or illegible when filed}$$

represent active powers and reactive powers output by ports i and j respectively; i [symbol] j represents that node i is upstream of node j; Uᵢ and Uⱼ are voltages of node i and node j; Pᵢⱼ and Qᵢⱼ are active and reactive powers flowing from node i into node j; Pⱼ and Qⱼ are active and reactive powers of a net load at node j;

$${S}_{\text{?}}^{link} and {S}_{j}^{link}$$

$$\text{?} \text{indicates text missing or illegible when filed}$$

represent capacities of converters at different ports of the flexible soft switch; Rᵢⱼ and Xᵢⱼ are a resistance value and a reactance value of a line between node i and node j; Pⱼₗ and Qⱼₗ represent active and reactive powers of node j flowing into node 1; Iᵢⱼ represent a current flowing through the line between node i and node j; and

$${I}_{\text{?}}^{\text{?}}$$

$$\text{?} \text{indicates text missing or illegible when filed}$$

and uᵢ represent quadratic components of Iᵢⱼ and Uⱼ respectively.

As a preferred solution of the method for siting and sizing the flexible soft switch of the distribution network based on mixed second-order cone programming of the present invention, the computing an objective function corresponding to the flexible soft switch siting and sizing solution includes:
taking an objective function value corresponding to the flexible soft switch siting and sizing solution as a fitness function value of the improved sparrow algorithm; and
outputting the optimal flexible soft switch siting and sizing solution in response to the fitness function value reaching a set threshold or a number of iterations reaching a maximum number of iterations of the improved sparrow algorithm.

In a second aspect, the present invention provides a system for siting and sizing a flexible soft switch of a distribution network based on mixed second-order cone programming, including:
a data acquisition module, used for acquiring interconnected flexible distribution system data;
a model establishment module, used for establishing, based on the interconnected flexible distribution system data and an interconnected flexible distribution system constraint, a flexible soft switch siting and sizing programming model of a flexible distribution network with a minimal daily comprehensive operation cost as an objective function;
a model solving module, used for acquiring a flexible soft switch siting and sizing solution by using combination of an improved sparrow algorithm and second-order cone programming to solve and optimize the flexible soft switch siting and sizing programming model of the flexible distribution network; and
an optimal solution acquisition module, used for acquiring an optimal flexible soft switch siting and sizing solution by computing an objective function corresponding to the flexible soft switch siting and sizing solution.

In a third aspect, the present invention provides a computing device, including:

Memory and processor;
the memory is used for storing a computer executable instruction; the processor is used for executing the computer executable instruction; and the computer executable instruction, when being executed by the processor, implements steps of the method for siting and sizing the flexible soft switch of the distribution network based on mixed second-order cone programming.

In a fourth aspect, the present invention provides a computer-readable storage medium in which a computer executable instruction is stored, where the computer executable instruction, when being executed by the processor, implements steps of the method for siting and sizing the flexible soft switch of the distribution network based on mixed second-order cone programming.

Compared with the prior art, the present invention has the beneficial effects that: the present invention considers flexible soft switch siting and sizing of a flexible distribution network with economy as an index on the premise of ensuring a normal power supply operation of the flexible distribution network so as to establish the minimal comprehensive cost (including the main network output cost, the operation loss cost, and the energy storage charging and discharging loss cost) as the objective function, and more accurately measures economy of different flexible soft switch configuration solutions so as to select an optimal: flexible soft switch optimized configuration solution, thereby achieving flexible distribution network operation programming in consideration of reliability and economy of power supply, and achieving coordination and complementation between equipment of the system. Meanwhile, the method of the present invention is simple and convenient in computation process and has a high engineering practical value.

### BRIEF DESCRIPTION OF DRAWINGS

In order to describe the technical solutions in the embodiments of the present invention more clearly, the following briefly introduces the accompanying drawings required for describing the embodiments. Apparently, the accompanying drawings in the following description show only some embodiments of the present invention, and those of ordinary skill in the art may still derive other drawings from these drawings without any creative efforts. In the drawings:

FIG. 1 is an overall schematic flowchart of a method for siting and sizing a flexible soft switch of a distribution network based on mixed second-order cone programming according to an embodiment of the present invention;

FIG. 2 is a schematic flowchart of an improved sparrow algorithm and a second-order cone method in a method for siting and sizing a flexible soft switch of a distribution network based on mixed second-order cone programming according to an embodiment of the present invention;

FIG. 3 is a schematic diagram of a system load and distributed power output in a method for siting and sizing a flexible soft switch of a distribution network based on mixed second-order cone programming according to an embodiment of the present invention;

FIG. 4 is a schematic diagram of electricity purchasing powers of a system by different methods in a method for siting and sizing a flexible soft switch of a distribution network based on mixed second-order cone programming according to an embodiment of the present invention;

FIG. 5 is a schematic diagram of active power transmission of a flexible soft switch with an improved sparrow algorithm and a second-order cone programming method in a method for siting and sizing a flexible soft switch of a distribution network based on mixed second-order cone programming according to an embodiment of the present invention;

FIG. 6 is a schematic diagram of reactive power transmission of a flexible soft switch with an improved sparrow algorithm and a second-order cone programming method in a method for siting and sizing a flexible soft switch of a distribution network based on mixed second-order cone programming according to an embodiment of the present invention; and

FIG. 7 is a schematic diagram of interconnection between optimized IEEE 33 example systems in a method for siting and sizing a flexible soft switch of a distribution network based on mixed second-order cone programming according to an embodiment of the present invention.

### DETAILED DESCRIPTION OF THE EMBODIMENTS

In order to make the aforementioned purposes, features and advantages of the present invention more apparent and comprehensible, detailed descriptions of specific embodiments of the present invention are provided below in conjunction with the appended drawings. It is understood that the described embodiments are merely a part of the embodiments of the present invention, rather than all embodiments. Based on the embodiments of the present invention, all other embodiments obtained by those of ordinary skill in the art without creative efforts shall fall within the protection scope of the present invention.

While the following description provides numerous specific details to fully comprehend the present invention, alternative implementations not explicitly disclosed herein are also possible. Those skilled in the art can carry out similar promotions without deviating from the scope of the present invention, thus the present invention is not limited to the specific embodiments disclosed below.

Secondly, the term “one embodiment” or “embodiments” referred herein refers to specific features, structures, or characteristics that may be incorporated into at least one realization manner of the present invention. The term ‘in one embodiment’ appearing in different places in the present specification does not necessarily refer to the same embodiment, nor is it a separate or selective embodiment that is mutually exclusive with other embodiments.

The present invention is described in detail in conjunction with schematic diagrams. For the purpose of description, sectional views of the device structure are partially enlarged without being drawn to scale. The schematic diagrams are merely exemplary and should not limit the protection scope of the present invention. Furthermore, it is important to consider the three-dimensional spatial dimensions of length, width, and depth in actual production.

It should be noted that in the description of the present invention that terms such as “up, down, inside, and outside” indicating orientation or positional relationships are based on the orientation or positional relationships shown in the illustrations for the purpose of facilitating the description and simplifying the disclosure. They do not indicate or imply that the systems or the components referred to must have a specific orientation, be constructed in a specific orientation, or operate in a specific orientation, and therefore should not be construed as limiting the present invention. Moreover, terms like “first, second or third” are only used for description, and should not be considered as a designation or designation of relative importance.

Unless otherwise explicitly specified and limited in the present invention, the terms “installation, connection, linking” should be understood in a broad sense. For example, they could refer to fixed or detachable connections, as well as integrally formed connections. They could also encompass mechanical, electrical or direct connections, indirect connections via intermediaries, and connections within two components. The terms described above have specific meanings in the present invention that can be understood by those skilled in the art in light of the particular circumstances.

### Embodiment 1

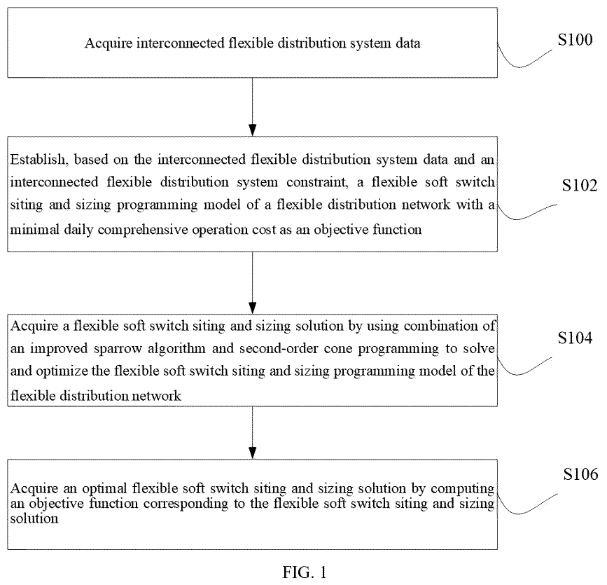

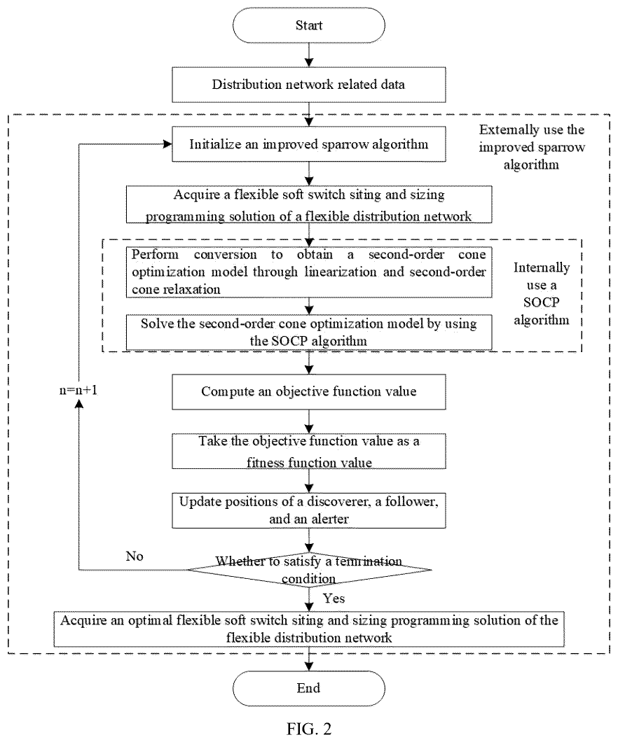

Referring to FIGS. 1-2, showing an embodiment of the present invention, the embodiment provides a method for siting and sizing a flexible soft switch of a distribution network based on mixed second-order cone programming, including:

S100: acquiring interconnected flexible distribution system data;

It is to be noted that the interconnected flexible distribution system data includes a system network connection topology, simulating 24-hour output data of a distributed power supply, 24-hour load data of a system node, energy storage configuration data, etc.

Specifically, data collection equipment is used to acquire original interconnected flexible distribution system data, which covers key information such as the system network connection topology, the 24-hour output data of the distributed power supply, the 24-hour load data of the system node, and the energy storage configuration data. Then, in order to ensure accuracy and availability of the data, the data is preprocessed.

A data preprocessing process includes data cleaning for processing a missing value and an outlier to ensure integrity and consistency of the data; data integration for integrating data from different sources into a unified data set and standardizing the data to eliminate a dimensional difference between different variables; and obtaining the interconnected flexible distribution system data after preprocessing of the original interconnected flexible distribution system data.

Taking time series data and network topology data in the interconnected flexible distribution system data as an example, the time series data can be preprocessed by sliding window analysis, time series prediction and other technologies; and key network structure and connection information can be extracted from the network topology data through network topology analysis.

S102: establishing, based on the interconnected flexible distribution system data and an interconnected flexible distribution system constraint, a flexible soft switch siting and sizing programming model of a flexible distribution network with a minimal daily comprehensive operation cost as an objective function.

Preferably, the interconnected flexible distribution system constraint includes a flexible soft switch operation constraint, a flexible soft switch reactive power constraint, a flexible soft switch capacity constraint, a power flow constraint, a system voltage constraint, a branch capacity constraint, and an energy storage equipment constraint.

Specifically, \textcircled{1} the flexible soft switch operation constraint is expressed as:

$${P}_{i}^{link} + {P}_{j}^{link} + {P}_{i}^{link , loss} + {P}_{j}^{link} = 0$$

$${P}_{\text{?}}^{link , loss} = {A}_{\text{?}}^{link} \sqrt{{( {P}_{\text{?}}^{link} )}^{2} + {( {Q}_{\text{?}}^{link} )}^{2}}$$

$${P}_{\text{?}}^{link , loss} = {A}_{j}^{link} \sqrt{{( {P}_{j}^{link} )}^{2} + {( {Q}_{j}^{link} )}^{2}}$$

$$\text{?} \text{indicates text missing or illegible when filed}$$

where

$${P}_{i}^{link} , {P}_{j}^{link} , {Q}_{i}^{link} , and {Q}_{j}^{link}$$

represent ports respectively, for outputting active powers and reactive powers,

$${P}_{i}^{link , loss} and {P}_{j}^{link , loss}$$

represent transmission losses of different ports of the flexible soft switch respectively, and

$${A}_{i}^{link} and {A}_{j}^{link}$$

represent loss coefficients corresponding to the ports respectively;

\textcircled{2} the flexible soft switch reactive power constraint is expressed as:

$${\underline{Q}}_{\text{?}}^{link} \leq {Q}_{\text{?}}^{link} \leq {\overline{Q}}_{\text{?}}^{link}$$

$${\underline{Q}}_{j}^{link} \leq {Q}_{j}^{link} \leq {\overline{Q}}_{j}^{link}$$

$$\text{?} \text{indicates text missing or illegible when filed}$$

where

$${\underline{Q}}_{\text{?}}^{link} , {\underline{Q}}_{j}^{link} , {\overline{Q}}_{\text{?}}^{link} , and {\overline{Q}}_{j}^{link}$$

$$\text{?} \text{indicates text missing or illegible when filed}$$

represent upper and lower limits of reactive powers transmitted by different ports of the flexible soft switch respectively;

\textcircled{3} the flexible soft switch capacity constraint is expressed as:

$$\sqrt{{( {P}_{\text{?}}^{link} )}^{2} + {( {Q}_{\text{?}}^{link} )}^{2}} \leq {S}_{\text{?}}^{link}$$

$$\sqrt{{( {P}_{j}^{link} )}^{2} + {( {Q}_{j}^{link} )}^{2}} \leq {S}_{j}^{link}$$

$$\text{?} \text{indicates text missing or illegible when filed}$$

where

$${P}_{i}^{link} , {P}_{j}^{link} , {Q}_{i}^{link} , and {Q}_{j}^{link}$$

represent ports respectively, for outputting active powers and reactive powers, and

$${S}_{i}^{link} and {S}_{j}^{link}$$

represent capacities of converters at different ports of the flexible soft switch;

\textcircled{4} the power flow constraint is expressed as:
the power flow constraint is expressed by taking a DistFlow branch power flow model:

$${\sum }_{i : i \to j} ( {P}_{ij} - {R}_{ij} {I}_{ij}^{2} ) - {P}_{j} = {\sum }_{l : j \to l} {P}_{jl} \\ {\sum }_{i : i \to j} ( {Q}_{ij} - {X}_{ij} {I}_{ij}^{2} ) - {Q}_{j} = {\sum }_{l : j \to l} {Q}_{jl} \\ {U}_{j}^{2} = {U}_{i}^{2} - 2 ( {R}_{ij} {P}_{ij} + {X}_{ij} {Q}_{ij} ) + ( {R}_{ij}^{2} + {X}_{ij}^{2} ) {I}_{ij}^{2} \\ {P}_{j} = {P}_{load , j} - {P}_{g , j} - {P}_{PV , j} - {P}_{wind , j} + {P}_{sop , j} + {P}_{ess} \\ {Q}_{j} = {Q}_{load , j} - {Q}_{g , j} - {Q}_{svc , j} - {Q}_{CB , j} + {Q}_{sop} \\ {I}_{ij}^{2} = \frac{{P}_{ij}^{2} + {Q}_{ij}^{2}}{{U}_{i}^{2}} \qquad ( 3 )$$

where Iᵢⱼ represents a current flowing through a line between node i and node j, Pⱼₗ and Qⱼₗ represent an active power and a reactive power flowing from node j to node 1 respectively, P_{g,j} and Q_{g,j} represent active and reactive power output of a power generator at node j respectively, P_{SOP,j} and Q_{SOP,j} represent an active power and a reactive power transmitted by a flexible soft switch port at node j respectively, Pₑₛₛ represents an energy storage active power output at node j, Q_{svc,j} and Q_{CB,j} represent continuous and discrete reactive compensation outputs at node j respectively, i→j represents that node i is upstream of node j, Uᵢ and Uⱼ are voltages of node i and node j, Pᵢⱼ and Qᵢⱼ are active and reactive powers flowing from node i to node j, Pⱼ and Qᵢ are active and reactive powers of a net load at node j, Rᵢⱼ and Xᵢⱼ are a resistance value and a reactance value of a line between node i and node j, P_{load,j} and Q_{load,j} are active and reactive powers of a load at node j, P_{wind,j} is an active power of a wind power unit at node j, and P_{PV,j} is an active power of a photovoltaic unit at node j;

\textcircled{5} the system voltage constraint

$${U}_{i , min}^{2} \leq {U}_{i}^{2} \leq {U}_{i , max}^{2}$$

where U_{i,max} and U_{i,min} represent upper and lower limits of a node allowable voltage;

\textcircled{6} the branch capacity constraint

$$0 \leq {I}_{ij}^{2} \leq {( {I}_{ij}^{max} )}^{2}$$

where

$${I}_{i j}^{max}$$

represents a limit of a current allowed to flow through a branch; and

\textcircled{7} the energy storage equipment constraint

$$\{ \begin{matrix}{μ}_{ch , i , t} + {μ}_{dis , i , t} \leq 1 \\ \{ {μ}_{ch , i , t} , {μ}_{dis , i , t} \} ∈ \{ 0 , 1 \}\end{matrix} \\ 0 \leq {P}_{ch , i , t} , {μ}_{dis , i , t} {P}_{ess , i}^{max} \\ 0 \leq {P}_{dis , i , t} \leq {μ}_{dis , i , t} {P}_{ess , i}^{max} \\ \{ \begin{matrix}{E}_{min}^{ESS} \leq {E}_{i , t}^{ESS} \leq {E}_{max}^{ESS} \\ {E}_{i , 1}^{ESS} = {E}_{i , 24}^{ESS}\end{matrix} \\ {E}_{i , t + 1}^{ESS} = {E}_{i , t}^{ESS} + {η}_{ch} {P}_{ch , i , t} - \frac{1}{{η}_{dis}} {P}_{dis , i , t}$$

where μ_{ch,i,t} and μ_{ds,i,j} are variables 0-1, representing that energy storage equipment is in a charging or discharging state respectively, η_{ch} and η_{dis} represent charging and discharging efficiency of the energy storage equipment,

$${P}_{ess , i}^{max}$$

represents a work charging and discharging power limit of the energy storage equipment,

$${E}_{max}^{ESS} and {E}_{min}^{ESS}$$

represent the highest and lowest stored electric quantity stipulated by the energy storage equipment, P_{ch,i,t} and P_{dis,i,t} represent energy storage charging power and discharging power at node i at time t respectively,

$${E}_{i , 1}^{ESS} and {E}_{i , 24}^{ESS}$$

represent that an initial stored electric quantity is equal to a termination electric quantity, and

$${E}_{i , t}^{ESS} and {E}_{i , t + 1}^{ESS}$$

represent a stored electric quantity at time t and a stored electric quantity at a next time respectively.

Preferably, the daily comprehensive operation cost includes a main network output cost, an operation loss cost, and an energy storage charging and discharging loss cost; and
the main network output cost, the operation loss cost, and the energy storage charging and discharging loss cost are expressed as:

$${C}_{pg} = {\sum }_{t = 1}^{T} {C}_{gt} {P}_{gt} \\ {C}_{loss} = {C}_{e} {\sum }_{i = 1}^{{N}_{bus}} {\sum }_{j ∈ c ( i )} {{R}_{ij} ( {I}_{ij} )}^{2} + {\sum }_{t = 1}^{T} {\sum }_{i ∈ {ϕ}_{sop}} {C}_{sop} {P}_{loss , i , t} Δ T \\ {C}_{Ess} = {\sum }_{t = 1}^{T} {\sum }_{i ∈ {ψ}_{ess}} {C}_{ess} ( {P}_{i , t}^{ch} + {P}_{i , t}^{dis} )$$

where C_{pg} is the main network output cost, Cₗₒₛₛ is the operation loss cost, C_{ESS} is the energy storage charging and discharging loss cost, C_{gt} represents a real-time electricity purchase price of the distribution network, P_{gi} represents a system real-time power in electricity purchase, Cₑ is a system network loss compensation coefficient, Cₛₒₚ is a reduced unit price of a flexible soft switch operation cost, N_{bus} is a number of system network nodes, c(i) is a set with node as an initial node, P_{loss,i,t} is a transmitted power loss of flexible soft switch port i at time t, Iᵢⱼ is a current flowing through a line between node i and node j, Cₑₛₛ represents an energy storage equipment cost coefficient, ψₑₛₛ represents an energy storage equipment installation position set in a system, and

$${P}_{i , t}^{ch} and {P}_{i , t}^{dis}$$

represent charging and discharging powers of energy storage equipment at node i at time t respectively.

Specifically, the present invention considers flexible soft switch siting and sizing of a flexible distribution network with economy as an index on the premise of ensuring a normal power supply operation of the flexible distribution network so as to establish the minimal comprehensive cost (including the main network output cost, the operation loss cost, and the energy storage charging and discharging loss cost) as the objective function, and more accurately measures economy of different flexible soft switch configuration solutions so as to select an optimal flexible soft switch optimized configuration solution, thereby achieving flexible distribution network operation programming in consideration of reliability and economy of power supply, and achieving coordination and complementation between equipment of the system. The minimum daily comprehensive operation cost serving as the objective function in an optimized configuration of the whole flexible soft switch mainly includes three parts:

$${C}_{min} = min ( {C}_{pg} + {C}_{loss} + {C}_{ESS} )$$

the main network output cost, the operation loss cost, and the energy storage charging and discharging loss cost.

In another possible implementation, the objective function further includes an environment cost, a maintenance cost, a fault cost, etc. Construction of the objective function is not static. It can be added or modified according to an actual situation. By reasonably selecting and adjusting cost items and their weights, it can ensure that the objective function is more in line with the actual situation and business needs of the flexible distribution network, so as to achieve operation programming of the flexible distribution network in consideration of the reliability and the economy of power supply.

S104: acquiring a flexible soft switch siting and sizing solution by using combination of an improved sparrow algorithm and second-order cone programming to solve and optimize the flexible soft switch siting and sizing programming model of the flexible distribution network,
preferably, initializing parameters of the sparrow algorithm, performing coding by determining an initial access position of the flexible soft switch as a decision variable of the improved sparrow algorithm, and randomly generating the flexible soft switch siting and sizing solution.

Specifically, modes of coding the initial access position of the flexible soft switch include binary coding, integer coding, real coding, hybrid coding, etc.

Taking binary coding as an example, for site coding, assuming that there are N possible access points in the distribution network, an integer array with a length being N can be used to represent a site of the flexible soft switch. Each element in the array represents an access state of the corresponding position, for example, 0 represents no access, and 1 represents access; for example, for five possible access points, a site code [1, 0, 1, 0, 1] represents that the flexible soft switch accesses to the 1^{st}, 3^{rd}, and 5^{th} access points.

Taking integer coding as an example, for size coding, a capacity of each accessed flexible soft switch is needed to be determined. An integer array can be used to represent the capacity of each access point. A length of the array is the same as a number of 1 in the site code. For example, if the site code is [1, 0, 1, 0, 1], and the capacities of the three access points are 50 kVA, 100 kVA, and 75 kVA respectively, a size code can be [50, 75, 100].

Preferably, a flexible soft switch connection port is unrepeated, and the flexible soft switch port cannot be connected to a head node of the distribution network.

Preferably, the Levy flight strategy is introduced into an iterative solution process of the sparrow algorithm, and interference is added to the flexible soft switch siting and sizing solution by adding a Levy flight item to an update of the flexible soft switch siting and sizing solution with an optimal objective function value.

It is to be noted that in the sparrow algorithm, aiming to the siting and sizing problem of the flexible soft switch, a population is divided into three different roles: a discoverer, a follower, and an alerter. Among them, the discoverer specifically refers to flexible soft switch siting and sizing solutions with preferred current objective function values. In each iteration of the sparrow algorithm, the discoverer explores a search space to find a flexible soft switch siting and sizing solution with a better objective function value. These discoverers usually represent potential optimal solutions in the search process. Their position updates are more extensive and random, aiming to cover a larger search range in order to find better solutions.

Specifically, the Levy flight strategy is added to the discovers' position updates in a sparrow evolutionary algorithm. Levy flight is a random search method obeying Levy distribution. It is a walking method with alternating short-distance search and occasional long-distance walking. The Levy flight makes a change of an individual position more flexible and a search range larger, which can prevent the algorithm from falling into stagnation, so as to promote each discoverer to have good global searchability.

With the iteration of the sparrow algorithm, the discoverers will constantly move in the search space to find better flexible soft switch siting and sizing solutions. Once being found, the better solutions will be regarded as new discoverers and continue to participate in the search process. In this way, the algorithm can gradually approach the optimal solution, and finally find the flexible soft switch siting and sizing solution meeting the requirements.

Specifically, discovers' position updates into which the Levy flight are introduced are expressed as:

$${x}_{id}^{t + 1} = \{ \begin{matrix}{x}_{id}^{t} \cdot exp ( \frac{- i}{α \cdot T} ) \cdot {L}_{F} , & {R}_{s} < ST \\ {x}_{id}^{t} \cdot {L}_{F} + Γ \cdot L , & {R}_{2} \geq ST\end{matrix} \\ {L}_{F} = γ \frac{μ}{{\vert v \vert}^{\frac{1}{β}}} ( {f}_{g} - {x}_{id}^{t} ) \\ β = {( \frac{Γ ( 1 + β ) \cdot sin ( πβ / 2 )}{Γ ( ( 1 + β ) / 2 ) \cdot β \cdot {2}^{( β - 1 ) / 2}} )}^{\frac{1}{β}}$$

where

$${x}_{id}^{t}$$

represents a d-dimensional position of the i^{th} individual sparrow of the t^{th} generation, f_{g} represents an optimal fitness of the current population, α represents a random number among [0, 1], T represents a set maximum number of iterations, L represents a unit vector, Γ represents a random number obeying standard normal distribution, L_{F} represents a flight function, R₂ represents a warning value, ST represents a safety value, γ represents a flight scale, β represents a flight coefficient taking a value of 1.5, μ and ν represent normally distributed random numbers

$$μ N ( 0 , {σ}_{μ}^{2} ) , vN ( 0 , {σ}_{v}^{2} ) , {σ}_{v} = 1 , and {σ}_{μ} = {( \frac{Γ ( 1 + β ) \cdot sin ( πβ / 2 )}{Γ ( ( 1 + β ) / 2 ) \cdot β \cdot {2}^{( β - 1 ) / 2}} )}^{\frac{1}{β}} .$$

Preferably, the flexible soft switch operation constraint, the flexible soft switch reactive power constraint, the flexible soft switch capacity constraint, and the power flow constraint are converted to a second-order cone optimization model through linearization and second-order cone relaxation, and then the second-order cone optimization model is solved by using a SOCP algorithm.

Preferably, the solving the second-order cone optimization model by using a SOCP algorithm is expressed as:

$${‖ \begin{matrix}{P}_{i}^{link} \\ {Q}_{i}^{link}\end{matrix} ‖}_{2} \leq \frac{{P}_{i}^{link , loss}}{{A}_{i}^{link}}$$

$${‖ \begin{matrix}{P}_{j}^{link} \\ {Q}_{j}^{link}\end{matrix} ‖}_{2} \leq \frac{{P}_{j}^{link , loss}}{{A}_{j}^{link}}$$

$${‖ \begin{matrix}{P}_{i}^{link} \\ {Q}_{i}^{link}\end{matrix} ‖}_{2} \leq {S}_{i}^{link}$$

$${‖ \begin{matrix}{P}_{j}^{link} \\ {Q}_{j}^{link}\end{matrix} ‖}_{2} \leq {S}_{j}^{link}$$

$${\sum }_{t : i \to j} ( {P}_{ij} - {R}_{ij} {I}_{ij}^{′} ) - {P}_{j} = {\sum }_{i : j \to i} {P}_{ji}$$

$${\sum }_{t : i \to j} ( {Q}_{ij} - {X}_{ij} {I}_{ij}^{′} ) - {Q}_{j} = {\sum }_{i : j \to i} {Q}_{ji}$$

$${u}_{j} = {u}_{i} - 2 ( {R}_{ij} {P}_{ij} + {X}_{ij} {Q}_{ij} ) + ( {R}_{ij}^{2} + {X}_{ij}^{2} ) {I}_{ij}^{′}$$

$${‖ \begin{matrix}2 {P}_{ij} \\ 2 {Q}_{ij} \\ {I}_{ij}^{′} - {u}_{j}\end{matrix} ‖}_{2} \leq {I}_{ij}^{′} + {u}_{j}$$

where

$${P}_{i}^{link} and {P}_{j}^{link}$$

as well as

$${Q}_{i}^{link} and {Q}_{j}^{link}$$

represent active powers and reactive powers output by ports i and j respectively; i [symbol] j represents that node i is upstream of node j; Uᵢ and Uⱼ are voltages of node i and node j; Pᵢⱼ and Qᵢⱼ are active and reactive powers flowing from node i into node j; Pⱼ and Qⱼ are active and reactive powers of a net load at node j;

$${S}_{i}^{link} and {S}_{j}^{link}$$

represent capacities of converters at different ports of the flexible soft switch; Rᵢⱼ and Xᵢⱼ are a resistance value and a reactance value of a line between node i and node j; Pⱼₗ and Qⱼₗ represent active and reactive powers of node j flowing into node 1; Iᵢⱼ represent a current flowing through the line between node i and node j; and

$${I}_{ij}^{′}$$

and uⱼ represent quadratic components of Iᵢⱼ and Uᵢ respectively. 1

Preferably, a branch current constraint and a node voltage constraint are accordingly changed as:

$$0 \leq {I}_{ij}^{′} \leq {( {I}_{ij}^{max} )}^{2}$$

$${U}_{max}^{2} \leq {u}_{i} \leq {U}_{max}^{2}$$

where U_{i,max} and U_{i,min} represent upper and lower limits of a node allowable voltage; and

$${I}_{i j}^{max}$$

represents a limit of a current allowed to flow through a branch.

Specifically, upon optimization of the flexible soft switch siting and sizing problem, in order to improve solution efficiency and accuracy, the operation constraint, the reactive power constraint, the capacity constraint, and the power flow constraint of the flexible soft switch are converted to a second-order cone optimization model through linearization and second-order cone relaxation.

This conversion process aims to simplify the original complicated nonlinear constraints into a more easily treated convex optimization problem, so that the second-order cone programming (SOCP) algorithm can be used for efficient solution. Specifically, power flow equations of the flexible soft switch and the distribution network are linearized first, and a second-order cone relaxation technology is used to convert the nonlinear constraints to a form of SOCP problem at the same time. In order to ensure that the model can accurately reflect physical characteristics and constraint conditions of the system, key variables such as quadratic components of powers, a node voltage, and a branch current are properly introduced into the flexible soft switch siting and sizing programming model of the flexible distribution network.

It is to be noted that the SOCP algorithm is used to solve the converted second-order cone optimization model. This algorithm has the advantage of treating the convex optimization problem, and can improve solution speed and efficiency while ensuring a global optimal solution. Through the SOCP algorithm, various constraint conditions including a flexible soft switch converter capacity limit, the node voltage constraint, the branch current constraint, etc. are effectively processed, so as to obtain an optimization result meeting the system's requirements.

S106: acquiring an optimal flexible soft switch siting and sizing solution by computing an objective function corresponding to the flexible soft switch siting and sizing solution,
preferably, taking an objective function value corresponding to the flexible soft switch siting and sizing solution as a fitness function value of the improved sparrow algorithm; and
preferably, outputting the optimal flexible soft switch siting and sizing solution in response to the fitness function value reaching a set threshold or a number of iterations reaching a maximum number of iterations of the improved sparrow algorithm.

It is to be noted that in practical application, it is necessary to set an appropriate fitness function threshold and number of iterations in computing the flexible soft switch siting and sizing solution. A threshold is set according to the nature of the problem, computing resources, and precision requirements, while the number of iterations considers complexity and a convergence speed of the problem. Through continuous experiments and adjustment, an optimal setting is found to acquire the optimal siting and sizing solution efficiently.

The above is the schematic solution of the method for siting and sizing the flexible soft switch of the distribution network based on mixed second-order cone programming of the embodiment. It is to be noted that the technical solution of the system for siting and sizing the flexible soft switch of the distribution network based on mixed second-order cone programming and the technical solution of the above-mentioned method for siting and sizing the flexible soft switch of the distribution network based on mixed second-order cone programming belong to a same concept. The detail contents of the technical solution of the system for siting and sizing the flexible soft switch of the distribution network based on mixed second-order cone programming are not described in detail, which can be seen in the description of the technical solution of the above-mentioned method for siting and sizing the flexible soft switch of the distribution network based on mixed second-order cone programming.

In the embodiment, a system for siting and sizing a flexible soft switch of a distribution network based on mixed second-order cone programming includes:
a data acquisition module, used for acquiring interconnected flexible distribution system data;
a model establishment module, used for establishing, based on the interconnected flexible distribution interconnected flexible distribution system constraint, a flexible soft switch siting and sizing programming model of a flexible distribution network with a minimal daily comprehensive operation cost as an objective function;
a model solving module, used for acquiring a flexible soft switch siting and sizing solution by using combination of an improved sparrow algorithm and second-order cone programming to solve and optimize the flexible soft switch siting and sizing programming model of the flexible distribution network; and
an optimal solution acquisition module, used for acquiring an optimal flexible soft switch siting and sizing solution by computing an objective function corresponding to the flexible soft switch siting and sizing solution.

The embodiment further includes a computing device, adapting to a situation for siting and sizing the flexible soft switch of the distribution network based on mixed second-order cone programming and including:
a memory and a processor, where the memory is used for storing a computer executable instruction; and the processor is used for executing the computer executable instruction to implement the method for siting and sizing the flexible soft switch of the distribution network based on mixed second-order cone programming as proposed in the above embodiment.

The embodiment further provides a storage medium, storing a computer program thereon. The program, when being executed by a processor, implements the method for siting and sizing the flexible soft switch of the distribution network based on mixed second-order cone programming as proposed in the above embodiment.

The storage medium proposed in the embodiment and the method for siting and sizing the flexible soft switch of the distribution network based on mixed second-order cone programming belongs to the same inventive concept. The technical details that are not described in detail in the embodiment can be seen in the above embodiment, and the embodiment has the same beneficial effect as the above embodiment.

Based on the above description of the embodiments, those skilled in the relevant field can clearly understand that the present invention can be implemented using software and necessary generic hardware, although it can also be implemented through hardware, the former is often a preferable method. On the basis of the understanding, the technical solution of the present invention may be embodied in a form of a software product in essence or a part contributing to the prior art, and the computer software product may be stored in the storage medium (for example, a floppy disk, a read only memory (ROM), a random access memory (RAM), a flash memory, a magnetic disk and an optical disk of a computer), and includes several instructions for enabling a computer device (which may be a personal computer, a server, or a network device, etc.) to execute the methods described in the various embodiments of the present invention.

### Embodiment 2

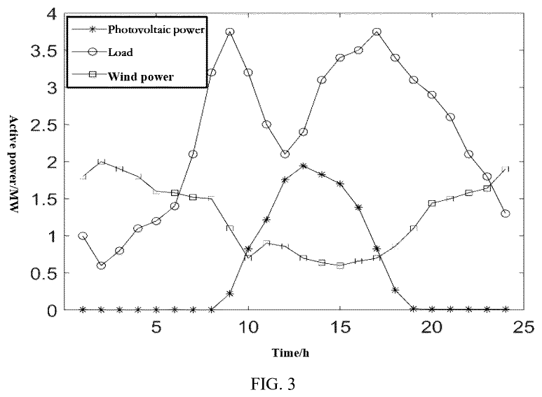

Referring to FIGS. 3-7 and Tables 1-3, showing an embodiment of the present invention, the embodiment provides a method for siting and sizing a flexible soft switch of a distribution network based on mixed second-order cone programming. In order to verify the beneficial effects of the present invention, comparison results of several solutions are provided.

For the embodiment of the present invention, the IEEE33 system network is set with a voltage level being 12.66 kV, a total active load being 3.715 MW, and a total reactive load being 2.3 Mvar.

A photovoltaic power generation system is accessed at node 12 and node 25, and a wind power generation system is accessed at node 14 and node 29. The energy storage equipment with different capacities are respectively connected to node 18 (with an upper limit of the capacity being 1.8 MW and a lower limit being 0. 18 MW) and node 33 (with an upper limit of the capacity being 1.0 MW and a lower limit being 0.1 MW). Meanwhile, according to the system operation demands, continuous reactive compensation equipment SVC and discrete reactive compensation equipment CB are configured at nodes 6, 16, and 32.

A time-of-daytariff of the system is set as shown in Table 1. The loss coefficient of the flexible soft switch takes a value of 0.02 with an operation unit price set as 400 yuan/(MW·h); and the energy storage charging and discharging efficiency is 0.9 with an operation unit price being 400 yuan/(MW·h).

TABLE 1
Table of Daily Power Prices in Electricity
Purchase from Distribution Network

Price (yuan/kWh)

| Transaction mode | Peak hour | Flat hump hour | Trough hour |
|---|---|---|---|
| Main network | 0.83 | 0.52 | 0.27 |
| output | | | |

As shown in Table 1, Table 1 lists daily power prices in electricity purchase from the distribution network in detail and distinguishes them according to time periods (a peak, a flat hump, and a trough), which reflects real-time dynamics and flexibility of the electricity market. This time-of-daytariff mechanism provides economic incentives for an optimized operation of the energy storage equipment and the reactive power compensation equipment in the present invention, which helps reduce a system cost and improve overall energy efficiency.

In order to fully verify effectiveness and practicability of the present invention in improving energy utilization efficiency and reducing the system cost, relevant data are acquired and collected, as shown in Table 2 and Table 3.

TABLE 2
Flexible Soft Switch Siting and Sizing
and System Cost Optimization Results

| | Flexible | Port sizing | | | |
|---|---|---|---|---|---|
| | soft | result/MW | | Number of | Comprehensive |
| Strategy | switch | Port 1 | Port 2 | iterations | cost/RMB |
| Systems | None | None | None | 0 | 1115.77 |
| without | | | | | |
| interconnection | | | | | |
| SSA | 8-22 | 0.3102 | 0.3010 | 50 | 1078.32 |
| ISSA | 8-33 | 0.378 | 0.363 | 50 | 1074.85 |

TABLE 3
Operation Loss of Flexible Distribution Network

Loss/MW

| | System | Flexible soft | Comprehensive |
|---|---|---|---|
| Scene | loss | switch loss | loss |
| Systems without | 0.9508 | — | 0.9508 |
| interconnection | | | |
| SSA | 0.5362 | 0.1963 | 0.7325 |
| ISSA | 0.4873 | 0.2325 | 0.7198 |

The flexible soft switch siting and sizing results and the comprehensive costs under three strategies of the systems without interconnection, a sparrow algorithm, and the improved sparrow algorithm are compared in Table 2. It can be seen from the table that by introducing the flexible soft switch and optimizing its site and size, the improved sparrow algorithm strategy can significantly reduce the comprehensive cost compared with the systems without interconnection and the sparrow algorithm strategy under the same number of iterations. This shows that the improved sparrow algorithm strategy not only improves economy of the system, but also shows innovation and effectiveness of the present invention in strategy optimization.

Table 3 further shows operation losses of the system under the three scenes of the systems without interconnection, the sparrow algorithm and the improved sparrow algorithm. By comparison in the system loss, the flexible soft switch loss, and the comprehensive loss, it can be seen that the improved sparrow algorithm strategy performs best in reducing the system loss, which proves that the present invention can effectively reduce the operation loss of the distribution network and improve the energy utilization efficiency by introducing the flexible soft switch and the optimization strategy.

In order to visually demonstrate the effects and the advantages of the present invention, relevant test results are visually displayed, as shown in FIGS. 3-7. These charts cover many aspects from distributed power output, load change to electricity purchasing power under the optimized operation strategy and power transmission of the flexible soft switch.

FIG. 3 shows the load data of each node in the IEEE33 node system within 24 h and a distributed power (such as photovoltaic and wind power) output. FIG. X clearly reflects supply and demand situations of the system in different time periods, and provides basic data for the optimized operation of the present invention. By reasonably dispatching the distributed power output, the present invention can more effectively meet the load demand and weaken dependence on a traditional power grid.

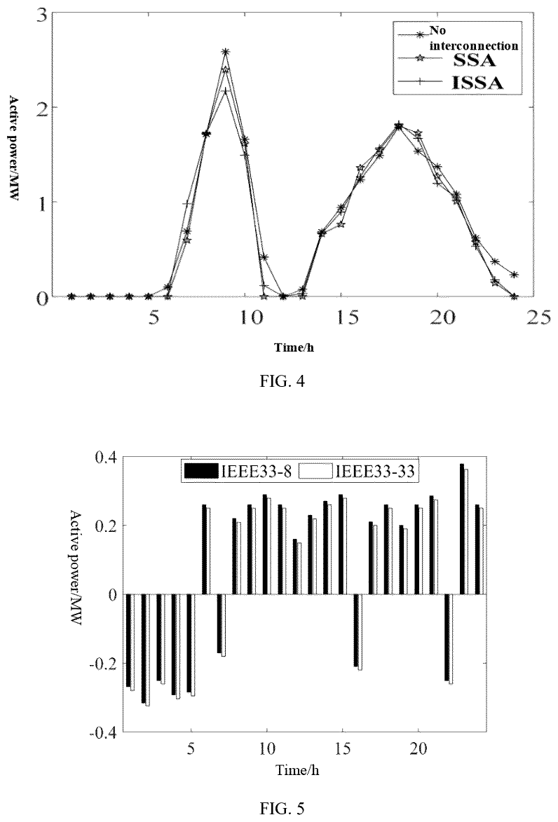

FIG. 4 shows a typical daily power in electricity purchase from an example system of the IEEE33 node system under the optimized operation with different strategies.

Strategy 1: the system operates in interconnection without the flexible soft switch;

Strategy 2: the system operates by siting and sizing optimization on the flexible soft switch by the original sparrow optimization algorithm; and

Strategy 3: the system operates by siting and sizing optimization on the flexible soft switch by the improved sparrow optimization algorithm.

It is obviously seen from FIG. 4 that the system power in electricity purchase is reduced slightly under the optimized operation of the system through combination of the improved sparrow optimization algorithm and second-order cone programming, which indicates that the optimization strategy of the present invention can significantly improve the economy of the system and reduce the operation cost.

FIG. 5 shows active power transmission of the flexible soft switch in the system operation. If the DG output is larger than a system load (such as 12:00-14:00), its excess part can only be discarded or partially charged into the energy storage equipment, resulting in a waste of a generated power. After interconnection between the flexible soft switches, the power is transmitted from a side near DG (node 8 in strategy 3) to an end far away from DG (node 33 in strategy 3) through the flexible soft switches.

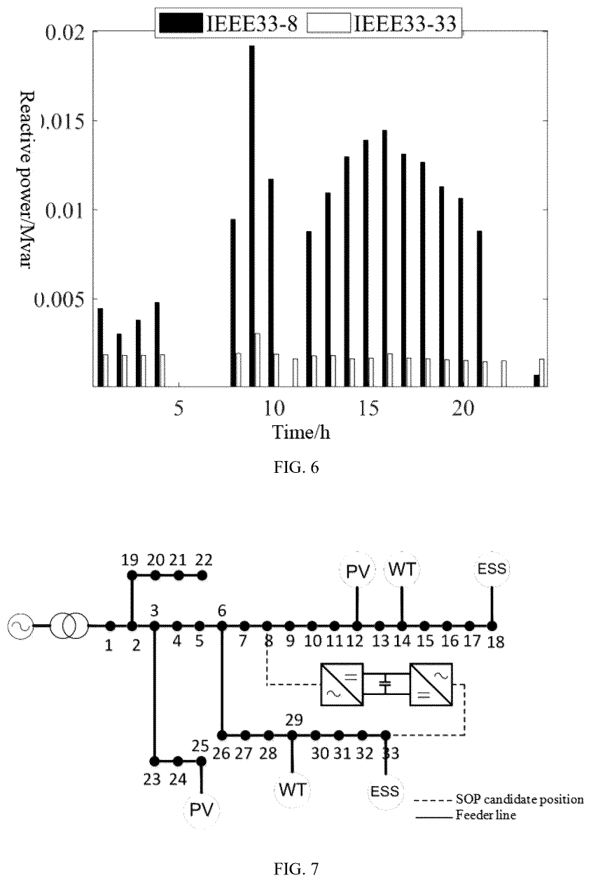

FIG. 6 shows data presentation of two different nodes (node 8 in strategy 3 and node 33 in strategy 3) at different time intervals (10 h, 15 h, 20 h, and 30 h). An initial value of node 8 in strategy 3 is 0.02, while an initial value of node 33 in strategy 3 is 0.015. In a form of bar chart, a data change trend of these two nodes at different time points can be clearly seen.

Optimization results are shown in FIG. 7. In summary, the present invention not only improves operation efficiency and economic benefits of a power system, but also makes an important contribution to intelligent and sustainable development of the power system.

It should be noted that the above embodiments are only intended to illustrate the technical solution of the present invention and not to limit it. Although the preferred embodiments have been described in detail, those skilled in the art should understand that modifications or equivalent substitutions may be made to the technical solution of the present invention without departing from its essence and scope, which are all within the scope of the claims of the present invention.

What is claimed is:

1. A method for siting and sizing a flexible soft switch of a distribution network based on mixed second-order cone programming, comprising:
acquiring interconnected flexible distribution system data;
establishing, based on the interconnected flexible distribution system data and an interconnected flexible distribution system constraint, a flexible soft switch siting and sizing programming model of a flexible distribution network with a minimal daily comprehensive operation cost as an objective function;
acquiring a flexible soft switch siting and sizing solution by using combination of an improved sparrow algorithm and second-order cone programming to solve and optimize the flexible soft switch siting and sizing programming model of the flexible distribution network; and
acquiring an optimal flexible soft switch siting and sizing solution by computing an objective function corresponding to the flexible soft switch siting and sizing solution.

2. The method for siting and sizing the flexible soft switch of the distribution network based on mixed second-order cone programming according to claim 1, wherein the interconnected flexible distribution system constraint comprises a flexible soft switch operation constraint, a flexible soft switch reactive power constraint, a flexible soft switch capacity constraint, a power flow constraint, a system voltage constraint, a branch capacity constraint, and an energy storage equipment constraint.

3. The method for siting and sizing the flexible soft switch of the distribution network based on mixed second-order cone programming according to claim 2, wherein the objective function comprises:
the daily comprehensive operation cost comprises a main network output cost, an operation loss cost, and an energy storage charging and discharging loss cost; and
the main network output cost, the operation loss cost, and the energy storage charging and discharging loss cost are expressed as:
$$\text{?}$$
$$\text{?} \text{indicates text missing or illegible when filed}$$
wherein C_{pg} is the main network output cost, Cₗₒₛₛ is the operation loss cost, C_{ESS} is the energy storage charging and discharging loss cost, C_{gl} represents a real-time electricity purchase price of the distribution network, P_{gl} represents a system real-time power in electricity purchase, Cₑ is a system network loss compensation coefficient, Cₛₒₚ is a reduced unit price of a flexible soft switch operation cost, N_{bus} is a number of system network nodes, c(i) is a set with node i as an initial node, P_{loss,i,j} is a transmitted power loss of flexible soft switch port i at time t, Iᵢⱼ is a current flowing through a line between node i and node j, Cₑₛₛ represents an energy storage equipment cost coefficient, ψₑₛₛ represents an energy storage equipment installation position set in a system, and
$$\text{?}$$
$$\text{?} \text{indicates text missing or illegible when filed}$$
represent charging and discharging powers of energy storage equipment at node i at time t respectively.

4. The method for siting and sizing the flexible soft switch of the distribution network based on mixed second-order cone programming according to claim 3, wherein the solving the flexible soft switch siting and sizing programming model of the flexible distribution network by using the improved sparrow algorithm comprises:
initializing parameters of the sparrow algorithm, performing coding by determining an initial access position of the flexible soft switch as a decision variable of the improved sparrow algorithm, and randomly generating the flexible soft switch siting and sizing solution;
making a flexible soft switch connection port unrepeated and the flexible soft switch port not connected to a head node of the distribution network; and
introducing the Levy flight strategy into an iterative solution process of the sparrow algorithm, and adding interference to the flexible soft switch siting and sizing solution by adding a Levy flight item to an update of the flexible soft switch siting and sizing solution with an optimal objective function value.

5. The method for siting and sizing the flexible soft switch of the distribution network based on mixed second-order cone programming according to claim 4, wherein the optimizing the flexible soft switch siting and sizing programming model of the flexible distribution network by using second-order cone programming comprises:
converting the flexible soft switch operation constraint, the flexible soft switch reactive power constraint, the flexible soft switch capacity constraint, and the power flow constraint to a second-order cone optimization model through linearization and second-order cone relaxation, and then solving the second-order cone optimization model by using a SOCP algorithm.

6. The method for siting and sizing the flexible soft switch of the distribution network based on mixed second-order cone programming according to claim 5, further comprising:
the solving the second-order cone optimization model by using a SOCP algorithm is expressed as:
$${‖ \begin{matrix}{P}_{i}^{link} \\ {Q}_{i}^{link}\end{matrix} ‖}_{2} \leq \frac{{P}_{i}^{link , loss}}{{A}_{i}^{link}}$$
$${‖ \begin{matrix}{P}_{i}^{link} \\ {Q}_{i}^{link}\end{matrix} ‖}_{2} \leq {S}_{i}^{link}$$
$${\sum }_{t : i \to j} ( {P}_{ij} - {R}_{ij} {I}_{ij}^{′} ) - {P}_{j} = {\sum }_{i : j \to i} {P}_{ji}$$
$${\sum }_{t : i \to j} ( {Q}_{ij} - {X}_{ij} {I}_{ij}^{′} ) - {Q}_{j} = {\sum }_{i : j \to i} {Q}_{ji}$$
$${u}_{j} = {u}_{i} - 2 ( {R}_{ij} {P}_{ij} + {X}_{ij} {Q}_{ij} ) + ( {R}_{ij}^{2} + {X}_{ij}^{2} ) {I}_{ij}^{′}$$
$${‖ \begin{matrix}2 {P}_{ij} \\ 2 {Q}_{ij} \\ {I}_{ij}^{′} - {u}_{j}\end{matrix} ‖}_{2} \leq {I}_{ij}^{′} + {u}_{j}$$
wherein
$${P}_{i}^{link} and {P}_{j}^{link}$$
as well as
$${Q}_{i}^{link} and {Q}_{j}^{link}$$
represent active powers and reactive powers output by ports i and j respectively; i [symbol] j represents that node i is upstream of node j; Uᵢ and Uⱼ are voltages of node i and node j; Pᵢⱼ and Qᵢⱼ are active and reactive powers flowing from node i into node j; Pⱼ and Qⱼ are active and reactive powers of a net load at node j;
$${S}_{i}^{link} and {S}_{j}^{link}$$
represent capacities of converters at different ports of the flexible soft switch; Rᵢⱼ and Xᵢⱼ are a resistance value and a reactance value of a line between node i and node j; Pⱼₗ and Qⱼₗ represent active and reactive powers of node j flowing into node 1; Iᵢⱼ represent a current flowing through the line between node i and node j; and
$${I}_{ij}^{′}$$
and uᵢ represent quadratic components of Iᵢⱼ and Uᵢ respectively.

7. The method for siting and sizing the flexible soft switch of the distribution network based on mixed second-order cone programming according to claim 6, wherein the computing an objective function corresponding to the flexible soft switch siting and sizing solution comprises:
taking an objective function value corresponding to the flexible soft switch siting and sizing solution as a fitness function value of the improved sparrow algorithm; and
outputting the optimal flexible soft switch siting and sizing solution in response to the fitness function value reaching a set threshold or a number of iterations reaching a maximum number of iterations of the improved sparrow algorithm.

8. A system for siting and sizing a flexible soft switch of a distribution network based on mixed second-order cone programming, comprising:
a data acquisition module, used for acquiring interconnected flexible distribution system data;
a model establishment module, used for establishing, based on the interconnected flexible distribution system data and an interconnected flexible distribution system constraint, a flexible soft switch siting and sizing programming model of a flexible distribution network with a minimal daily comprehensive operation cost as an objective function;
a model solving module, used for acquiring a flexible soft switch siting and sizing solution by using combination of an improved sparrow algorithm and second-order cone programming to solve and optimize the flexible soft switch siting and sizing programming model of the flexible distribution network; and
an optimal solution acquisition module, used for acquiring an optimal flexible soft switch siting and sizing solution by computing an objective function corresponding to the flexible soft switch siting and sizing solution.

9. An electronic device, comprising:
a memory and a processor, wherein
the memory is used for storing a computer executable instruction; the processor is used for executing the computer executable instruction; and the computer executable instruction, when being executed by the processor, implements steps of the method for siting and sizing the flexible soft switch of the distribution network based on mixed second-order cone programming according to claim 1.

10. A computer-readable storage medium in which a computer executable instruction is stored, wherein the computer executable instruction, when being executed by the processor, implements steps of the method for siting and sizing the flexible soft switch of the distribution network based on mixed second-order cone programming according to claim 1.
